(19) United States
(12) Patent Application Publication
(10) Pub. No.: US 2006/0263509 A1
(43) Pub. Date: Nov. 23, 2006

(54) PROCESS FOR MANUFACTURING DEHYDRATED PRECOOKED LEGUMES

(76) Inventor: Nicky Chad Nickels, Muleshoe, TX (US)

Correspondence Address: MICHAEL A. O'NEIL, P.C., 5949 SHERRY LANE, SUITE 820, DALLAS, TX, 75225, US

(21) Appl. No.: 11/461,944

(22) Filed: Aug. 2, 2006

Related U.S. Application Data
(63) Continuation-in-part of application No. 11/109,307, filed on Apr. 19, 2005, now Pat. No. 7,087,262.
(60) Provisional application No. 60/563,957, filed on Apr. 21, 2004.

(51) Int. Cl. A23L 1/20

(52) U.S. Cl. 426/634

(57) ABSTRACT

A process for manufacturing dehydrated precooked flaked legumes begins with cleaning a quantity of legumes. The cleaned legumes are then pressure cooked. Following cooking, the legumes are deposited on a perforated conveyor for transportation through a first dehydrator which reduces the moisture content of the legumes. The cooked dehydrated legumes are then directed through a roller mill to convert the legumes into flakes. Alternative to being dehydrated in a first dehydrator before being converted into flakes, the legumes may be separated on a water separating conveyor and not undergo dehydration. The cooked dehydrated legume flakes are then transported through a dehydrator which further reduces the moisture content thereof.

### CROSS-REFERENCE TO RELATED APPLICATIONS

This application is a continuation-in-part application of application Ser. No. 11/109,307 filed Apr. 19, 2005, currently pending, the entire contents of which are incorporated herein by reference; which claims priority based on provisional patent application Ser. No. 60/563,957, filed Apr. 21, 2004, the entire contents of which are incorporated herein by reference.

### TECHNICAL FIELD

This invention relates generally to the processing of legumes for human consumption, and more particularly to an improved process for manufacturing dehydrated precooked legumes.

### BACKGROUND AND SUMMARY OF THE INVENTION

Dehydrated precooked pinto beans have heretofore been manufactured into chipped beans by first cooking the beans in a device that is similar to a conventional roaster. After cooking, the beans are pumped out of the cooking device and into trays. At this point the whole beans are in a liquid state. While the cooked pinto beans are in the trays they are quick frozen. The frozen blocks of beans are directed through a chipper and are then dehydrated. The finished dehydrated precooked chipped pinto beans are then packaged for sale.

The foregoing and other processes for preparing dehydrated legumes are deficient in that the resulting product is relatively low in nutritional value. The present invention overcomes the foregoing and other difficulties which have long since characterized the prior art by providing a process for manufacturing dehydrated legumes which results in virtually no loss of nutritional value and shrinkage of less than 1%.

In accordance with the broader aspects of the invention, a carefully prepared mixture of cleaned raw legumes and water is cooked in a steam jacketed pressure vessel. The cooking process results in absorption of substantially all of the water from the mixture into the legumes. Following cooking, the legumes are discharged from the pressure vessel into a holding hopper which directs the cooked legumes onto a perforated stainless steel conveyor.

The perforated stainless steel conveyor transports the cooked legumes through a dehydrator which reduces the moisture content of the cooked legumes to about 20%. Following dehydration the legumes are directed through corrugated rollers which press the cooked legumes into flakes. The cooked and dehydrated legume flakes are then directed through a second dehydrator which reduces the moisture content of the legume flakes to between about 10% and about 3%. After passing through the second dehydrator, the dehydrated precooked flaked legumes are packaged for distribution and sale.

A second embodiment of the present invention comprises an alternate sequence of steps and required equipment. In accordance with the specific aspects of the second embodiment, the legumes are first processed through a flume destoner where the legumes are cleansed and pre-soaked utilizing heated water. From the flume destoner, the legumes are discharged into a full vacuum kettle along with a predetermined quantity of water. Steam is then injected into the kettle for pressure cooking the legumes and heating the water therein to create more steam. The steam is maintained at about 13.5 psi thereby cooking the legumes in a period of about 40 minutes.

The cooked legumes are then discharged into a holding hopper which thereafter discharges a regulated flow of legumes onto a vibrating water separating conveyor utilizing heated water for separation of the legumes thereon. As the legumes reach the end of the conveyor, heated oil is sprayed thereover prior to the legumes entering a roller mill. The roller mill utilizes smooth heated rollers for converting the cleaned, cooked legumes into flakes. The combination of the oil-misted legumes with the smooth heated roller facilitates softening and stretching of the legumes' skin ultimately resulting in a more tender, more flavorful legume product.

The roller mill discharges the legume flakes onto a perforated stainless steel conveyor which directs the legumes through a dehydrator wherein the moisture content of the legume flakes is reduced to between about 7% and about 9%. The legume flakes are then directed through a cooler which circulates ambient air across the dehydrated legume flakes to cool then flakes to a suitable temperature for packaging.

### BRIEF DESCRIPTION OF THE DRAWINGS

A more complete understanding of the present invention may be had by reference to the following Detailed Description when taken in connection with the accompanying Drawings, wherein:

FIG. 1 is a perspective view of a steam jacketed pressure vessel useful in the cooking of pinto legumes in accordance with the process of the present invention;

FIG. 2 is a perspective view illustrating various devices useful in carrying out successive steps comprising the process of the present invention; and

FIG. 3 is a perspective illustrating alternative devices useful in carrying out an alternative set of successive steps comprising the process of the present invention.

### DETAILED DESCRIPTION

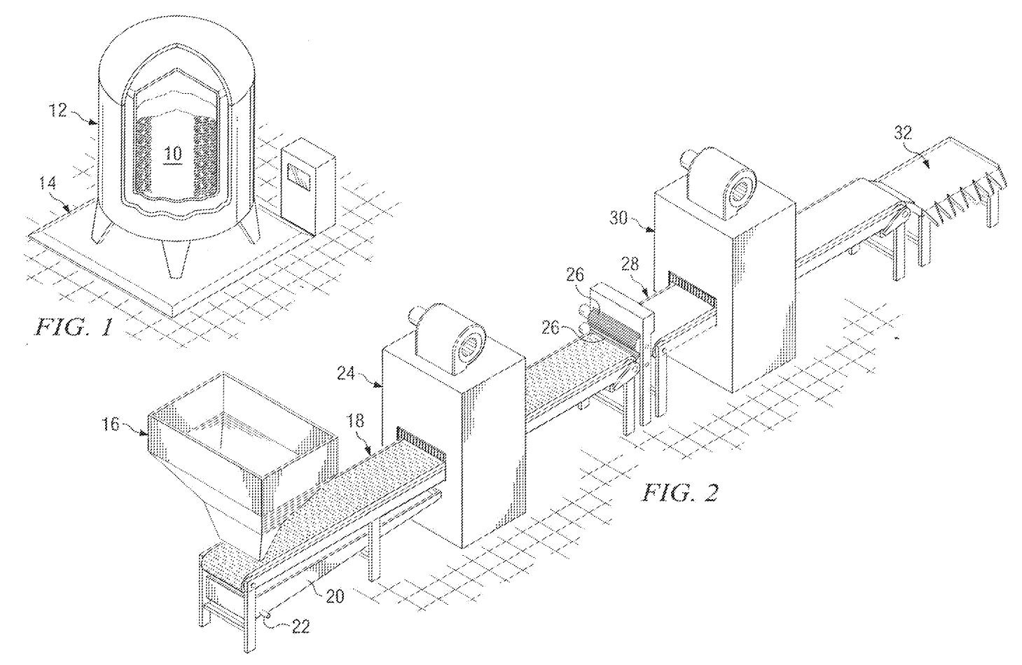

As used herein the term legumes means pinto beans, navy beans, great northern beans, kidney beans, black beans, black-eyed peas, and pinks. FIGS. 1 and 2 illustrate a plurality of devices useful in carrying out the steps comprising the process for manufacturing dehydrated precooked legumes comprising the present invention. The process begins with the cleaning of a quantity of legumes. The cleaned legumes 10 are then introduced into a steam jacketed pressure vessel 12 along with a predetermined quantity of water. The pressure vessel 12 is preferably supported on a scale 14 so that the ratio of legumes to water can be accurately determined.

Within the pressure vessel 12 the legume/water mixture is cooked at a minimum temperature of 230° F. for a period of about 40 to 45 minutes at a pressure of about 15 psi. At the end of the cooking process substantially all of the water from the legume/water mixture is absorbed into the cooked legumes.

Following the cooking step the now cooked legumes are discharged from the pressure vessel 12 onto a stainless steel holding hopper 16. The hopper 16 discharges the cooked legumes onto a perforated stainless steel conveyor 18. Any excess moisture from the cooked legumes passes through the perforations of the conveyor 18 into a catch basin 20 and from the catch basin 20 into a drain 22.

The perforated conveyor 18 transports the cooked legumes through a first dehydrator 24. The dehydrator 24 includes a fan and suitable heating elements which may be similar to those used in an ordinary household oven. The fan directs heated air into engagement with the legumes and through the perforated conveyor which supports the legumes thereby assuring appropriate drying of the cooked legumes. Preferably the heated air is recirculated to the fan after passing through the perforated conveyor 18. The function of the dehydrator 24 is to reduce the moisture content of the cooked legumes to about 20%.

After passing through the dehydrator 24 the cooked and dehydrated legumes are directed through a pair of opposed, corrugated stainless steel rollers 26. The function of the rollers 26 is to press the cooked and dehydrated legumes into flakes.

In actual practice it has been found that a moisture content of about 20% is preferable for forming cooked pinto beans into flakes, it being understood that the appropriate moisture content for other legumes may vary. Thus, if the moisture content of the cooked pinto beans is substantially less than 20%, the pinto beans will tend to shatter during the flaking procedure. It has also been determined that the pinto bean flakes which are formed by the rollers 26 should be as thin as possible in order to facilitate subsequent re-hydration of the pinto beans.

After passing through the corrugated stainless steel rollers 26 the legumes, now in flake form, are received on a conveyor 28. The conveyor 28 transports the legume flakes through a second dehydrator 30 which is substantially identical in construction and function to the dehydrator 24 as described above. The second dehydrator 30 reduces the moisture content of the legume flakes to between about 10% and about 3%. After passing through the second dehydrator 30 the legume flakes are transported by the conveyor 28 to a suitable packaging apparatus 32 for packaging and shipping to the ultimate consumer.

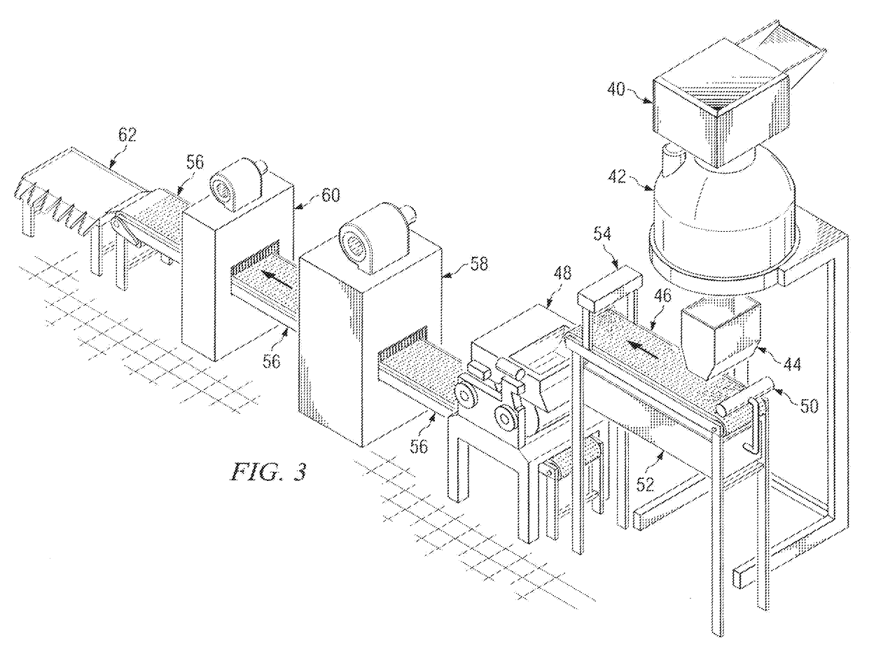

FIG. 3 illustrates an alternative sequence of steps and alternative devices which may be used to manufacture dehydrated precooked flaked legumes. The process begins with raw legumes being placed in a flume destoner 40 with a predetermined quantity of water for cleaning and pre-soak. Inside the flume destoner 40 the water is heated to about 210° F. The heated water in the destoner 40 not only cleans the legumes but also facilitates a pre-soak of the legumes in a lesser amount of time than required when using non-heated water to pre-soak the legumes. The pre-soaked, cleaned legumes are then introduced into a full vacuum kettle 42 for cooking. The full vacuum kettle 42 employed in the method of the present invention comprises a vacuum sealed tank in which the legumes and water are placed. A boiler generates steam which is injected into the tank to apply pressure directly to the legumes and to heat the water therein for additional steam. The steam is maintained at about 13.5 psi thereby cooking the legumes at a minimum temperature of about 230° F. in a period of about 40 minutes, it being understood that the pressure, temperature, and time comprising the cooking step may vary depending upon the particular legume that is being cooked.

Below the full vacuum kettle 42 is a stainless steel holding hopper 44 which receives the legumes from the full vacuum kettle and thereafter discharges the legumes onto a vibrating water separating conveyor 46 which separates the legumes while conveying the legumes to a roller mill 48 to be converted to flakes. The water separating conveyor 46 may be vibrated by an eccentric or other vibrating means known to those skilled in the art of manufacturing food processing equipment.

A nozzle 50 located at the proximal end of the water separating conveyor 46 distributes hot water heated to about 200° F. over the legumes as they travel along the length thereof facilitating substantially complete separation of the legumes. The hot water distributed over the legumes prevents the legumes from smearing while on the water separating conveyor 46 facilitating relatively uniform flake formation and eventually a more tender legume having more taste when reconstituted by water. Excess water is discarded into a waste water tank 52 located beneath the water separating conveyor 46.

At the distal end of the conveyor an oil mister 54 applies a light mist of hot oil onto the legumes before they are discharged into the roller mill 48. The oil softens the legumes' skin further facilitating a substantially uniform flake formation and resulting in a more tender and flavorful legume product. A spice funnel may also be employed to apply spices onto the legumes before entering the roller mill 48. Applying spices to the legumes neutralizes the starches in the legumes, resulting in a less gaseous legume product. Additionally, the spices applied to the legumes may be employed to create a spice flavored legume product.

The roller mill 48 processes the cleaned, separated legumes into flakes. The roller mill 48 used in the practice of the present invention may be a cereal mill employing smooth heated rollers therein such as a modified M-Series Cereal Flaker mill manufactured by Ferrell-Ross, or other similar milling machines known to those skilled in the food processing industry as suitable for milling foodstuffs into flakes. Heated rollers inside the roller mill 48 facilitate softening and stretching of the oiled legumes' skin thereby preventing the legumes and resulting flakes from accumulating on the rollers and resulting in a more tender legume product.

After passing through the roller mill 48 the legume flakes are directed onto a perforated stainless steel conveyor 56 which transports the legume flakes through a dehydrator 58. The legume flakes are directed through the dehydrator 58 for removal of the moisture therefrom. The dehydrator 58 employs fans that circulate air across steam coils heated to over 200° F. and thereafter over the legume flakes traveling therethrough to reduce the moisture content of the legume flakes to between about 7% and about 9%. The air is thereafter re-circulated back across the steam coils for removal of any moisture contained therein.

After passing through the dehydrator the conveyor 56 directs the dehydrated legume flakes through a cooler 58. The cooler 58 circulates ambient air across the legume flakes in order to cool them to ambient temperature for packaging. From the cooler 58 the conveyor 56 conveys the cooled, dehydrated legume flakes to a collection bin and suitable packaging apparatus 62. The cooked, dehydrated legume flakes are then packaged and shipped to the ultimate customer.

Prior to consumption the dehydrated precooked flaked legumes of the present invention are preferably re-hydrated. This is accomplished by mixing a quantity of boiling water with an equal quantity of dehydrated precooked flaked legumes. The legume flake/water mixture is then stirred and simmered for approximately five minutes whereupon the re-hydrated legumes are ready for consumption.

The steps of the present invention have been discussed to some extent in conjunction with pinto beans, but the process of the present invention may be equally employed with legumes of all types. The process of the present invention may also be used in conjunction with shelled beans and peas by adding an apparatus for removing the beans or peas from their pods prior to the cleansing and pre-soaking step.

In accordance with a first variation of the invention legumes are processed in the same manor as described in detail above but with a change in the positioning of the rolls. By increasing the distance between the opposed hot rolls the thickness of the processed legume material increases. After dehydration the processed legume material resembles a corn chip and is hereinafter referred to as a legume chip. Legume chips are high in protein and have a good nutritional value.

In accordance with a second variation of the invention legumes are processed in the same manor as described in detail above. By adding a pulverizer as an alternate final step the processed legume flakes are stone ground into legume flour. A wide variety of uses for legume flour are well known to those skilled in the art.

In accordance with a third variation of the invention legumes, peas, etc. are processed in the same manner described in detail above except that the use of the roller is eliminated. Instead, cooked whole legumes, peas, etc. are directed into the dehydrator immediately following cooking and draining. The result is dehydrated cooked whole vegetables that can be reconstituted in five minutes instead of the usual 12 hours and having flavors and textures matching those of freshly cooked vegetables.

Although preferred embodiments of the invention have been illustrated in the accompanying Drawings and described in the foregoing Detailed Description, it will be understood that the invention is not limited to the embodiments disclosed, but is capable of numerous rearrangements, modifications, and substitutions of parts and elements without departing from the spirit of the invention.

1. A process for manufacturing dehydrated precooked flaked legumes comprising the steps of:
providing a steam jacketed pressure vessel;
providing a quantity of cleaned legumes;
providing a quantity of water;
positioning the quantity of legumes and the quantity of water in the steam jacketed pressure vessel;
employing the steam jacketed pressure vessel to heat the legumes and water contained therein thereby cooking the legumes;
providing a holding hopper;
discharging the cooked legumes from the steam jacketed pressure vessel into the holding hopper;
providing a perforated conveyor;
discharging the legumes from the holding hopper onto the perforator conveyor;
providing a first dehydrator;
utilizing the perforated conveyor to transport the cooked legumes through the first dehydrator;
utilizing the dehydrator to reduce the moisture content of the cooked legumes;
providing a pair of opposed corrugated rollers;
directing the cooked dehydrated legumes through the opposed corrugated rollers and thereby converting the cooked, dehydrated legumes into flakes;
providing a second dehydrator;
directing the cooked dehydrated legume flakes through the second dehydrator and thereby further reducing the moisture content thereof; and
packaging the precooked dehydrated flaked legumes for distribution and sale following the second dehydration step.

2. A process for manufacturing dehydrated precooked legumes comprising the steps of:
providing a quantity of raw legumes;
providing means for cleaning and pre-soaking the quantity of raw legumes;
providing a quantity of heated water;
positioning the quantity of legumes and the quantity of water in the cleaning and pre-soaking means;
utilizing the cleaning and pre-soaking means and the quantity of water therein to clean and pre-soak the legumes;
providing means for pressure cooking the legumes;
discharging the clean, pre-soaked legumes from the cleaning and pre-soaking means into the pressure cooking means;
providing a second quantity of water;
positioning the clean, pre-soaked legumes and the second quantity of water in the pressure cooking means;
utilizing the pressure cooking means to heat the legumes and the water contained therein thereby cooking the legumes;
providing a holding hopper;
discharging the cooked legumes from the pressure cooking means into the holding hopper;
providing a separating conveyor;
discharging the cooked legumes from the holding hopper onto the separating conveyor;
utilizing the separating conveyor to separate the legumes;
providing means for applying a mist of oil onto the separated, cooked legumes;
utilizing the misting means to mist oil onto the separated, cooked legumes at the distal end of the separating conveyor;
providing a roller mill having smooth, heated rollers;
discharging the misted, separated legumes into the roller mill;
utilizing the roller mill and heated rollers therein to convert the separated, cooked legumes into flakes;
providing a perforated conveyor;
discharging the legume flakes onto the perforated conveyor;
providing a dehydrator;
providing means for cooling the legume flakes;
utilizing the perforated conveyor to direct the legumes through the dehydrator and the cooling means;
utilizing the dehydrator to reduce the moisture content of the legume flakes;
utilizing the cooling means to cool the dehydrated legume flakes to ambient temperature; and
packaging the cooled, dehydrated legume flakes for distribution and sale.

3. The process for manufacturing dehydrated precooked legumes according to claim 2 further comprising the steps of:
providing a quantity of heated water for use in conjunction with the separating conveyor;
providing means for spraying the heated water across the legumes on the separating conveyor; and
the water sprayed over the legumes on the separating conveyor facilitating substantially complete separation of the legumes thereon.

4. The process for manufacturing dehydrated precooked legumes according to claim 2 wherein the cleaning and pre-soaking means is a flume destoner.

5. A process for manufacturing dehydrated precooked flaked legume chips comprising the steps of:
providing a steam jacketed pressure vessel;
providing a quantity of cleaned legumes;
providing a quantity of water;
positioning the quantity of legumes and the quantity of water in the steam jacketed pressure vessel;
employing the steam jacketed pressure vessel to heat the legumes and water contained therein thereby cooking the legumes;
providing a holding hopper;
discharging the cooked legumes from the steam jacketed pressure vessel into the holding hopper;
providing a perforated conveyor;
discharging the legumes from the holding hopper onto the perforator conveyor;
providing a first dehydrator;
utilizing the perforated conveyor to transport the cooked legumes through the first dehydrator;
utilizing the dehydrator to reduce the moisture content of the cooked legumes;
providing a pair of opposed corrugated rollers;
directing the cooked dehydrated legumes through the opposed corrugated rollers and thereby converting the cooked, dehydrated legumes into legume chips;
providing a second dehydrator;
directing the cooked dehydrated legume chips through the second dehydrator and thereby further reducing the moisture content thereof; and
packaging the precooked dehydrated legume chips for distribution and sale following the second dehydration step.

6. A process for manufacturing dehydrated precooked legumes comprising the steps of:
providing a quantity of raw legumes;
providing means for cleaning and pre-soaking the quantity of raw legumes;
providing a quantity of heated water;
positioning the quantity of legumes and the quantity of water in the cleaning and pre-soaking means;
utilizing the cleaning and pre-soaking means and the quantity of water therein to clean and pre-soak the legumes;
providing means for pressure cooking the legumes;
discharging the clean, pre-soaked legumes from the cleaning and pre-soaking means into the pressure cooking means;
providing a second quantity of water;
positioning the clean, pre-soaked legumes and the second quantity of water in the pressure cooking means;
utilizing the pressure cooking means to heat the legumes and the water contained therein thereby cooking the legumes;
providing a holding hopper;
discharging the cooked legumes from the pressure cooking means into the holding hopper;
providing a separating conveyor;
discharging the cooked legumes from the holding hopper onto the separating conveyor;
utilizing the separating conveyor to separate the legumes;
providing means for applying a mist of oil onto the separated, cooked legumes;
utilizing the misting means to mist oil onto the separated, cooked legumes at the distal end of the separating conveyor;
providing a roller mill having smooth, heated rollers;
discharging the misted, separated legumes into the roller mill;
utilizing the roller mill and heated rollers thereof to convert the separated, cooked legumes into legume chips;
providing a perforated conveyor;
discharging the legume chips onto the perforated conveyor;
providing a dehydrator;
providing means for cooling the legume chips;
utilizing the perforated conveyor to direct the legume chips through the dehydrator and the cooling means;
utilizing the dehydrator to reduce the moisture content of the legume chips;
utilizing the cooling means to cool the dehydrated legume chips to ambient temperature; and
packaging the cooled, dehydrated legume chips for distribution and sale.

7. The process for manufacturing dehydrated precooked legumes according to claim 6 further comprising the steps of:
providing a quantity of heated water for use in conjunction with the separating conveyor;
providing means for spraying the heated water across the legumes on the separating conveyor; and
the water sprayed over the legumes on the separating conveyor facilitating substantially complete separation of the legumes thereon.

8. The process for manufacturing dehydrated precooked legumes according to claim 6 wherein the cleaning and pre-soaking means is a flume destoner.

9. A process for manufacturing dehydrated precooked legume flour comprising the steps of:
providing a steam jacketed pressure vessel;
providing a quantity of cleaned legumes;
providing a quantity of water;
positioning the quantity of legumes and the quantity of water in the steam jacketed pressure vessel;
employing the steam jacketed pressure vessel to heat the legumes and water contained therein thereby cooking the legumes;
providing a holding hopper;
discharging the cooked legumes from the steam jacketed pressure vessel into the holding hopper;
providing a perforated conveyor;
discharging the legumes from the holding hopper onto the perforator conveyor;
providing a first dehydrator;
utilizing the perforated conveyor to transport the cooked legumes through the first dehydrator;
utilizing the dehydrator to reduce the moisture content of the cooked legumes;
providing a pair of opposed corrugated rollers;
directing the cooked dehydrated legumes through the opposed corrugated rollers and thereby converting the cooked, dehydrated legumes into flakes;
providing a second dehydrator;
directing the cooked dehydrated legume flakes through the second dehydrator and thereby further reducing the moisture content thereof;
grinding the cooked dehydrated legume flakes into legume flour; and
packaging the legume flour for distribution and sale following the second dehydration step.

10. A process for manufacturing legume flour comprising the steps of:
providing a quantity of raw legumes;
providing means for cleaning and pre-soaking the quantity of raw legumes;
providing a quantity of heated water;
positioning the quantity of legumes and the quantity of water in the cleaning and pre-soaking means;
utilizing the cleaning and pre-soaking means and the quantity of water therein to clean and pre-soak the legumes;
providing means for pressure cooking the legumes;
discharging the clean, pre-soaked legumes from the cleaning and pre-soaking means into the pressure cooking means;
providing a second quantity of water;
positioning the clean, pre-soaked legumes and the second quantity of water in the pressure cooking means;
utilizing the pressure cooking means to heat the legumes and the water contained therein thereby cooking the legumes;
providing a holding hopper;
discharging the cooked legumes from the pressure cooking means into the holding hopper;
providing a separating conveyor;
discharging the cooked legumes from the holding hopper onto the separating conveyor;
utilizing the separating conveyor to separate the legumes;
providing means for applying a mist of oil onto the separated, cooked legumes;
utilizing the misting means to mist oil onto the separated, cooked legumes at the distal end of the separating conveyor;
providing a roller mill having smooth, heated rollers;
discharging the misted, separated legumes into the roller mill;
utilizing the roller mill and heated rollers thereof to convert the separated, cooked legumes into flakes;
providing a perforated conveyor;
discharging the legume flakes onto the perforated conveyor;
providing a dehydrator;
providing means for cooling the legume flakes;
utilizing the perforated conveyor to direct the legume flakes through the dehydrator and the cooling means;
utilizing the dehydrator to reduce the moisture content of the legume flakes;
utilizing the cooling means to cool the dehydrated legume flakes to ambient temperature;
grinding the legume flakes into legume flour;
packaging the cooled, dehydrated legume flour for distribution and sale.

11. The process for manufacturing legume flour according to claim 10 further comprising the steps of:
providing a quantity of heated water for use in conjunction with the separating conveyor;
providing means for spraying the heated water across the legumes on the separating conveyor; and
the water sprayed over the legumes on the separating conveyor facilitating substantially complete separation of the legumes thereon.

12. The process for manufacturing dehydrated precooked legumes according to claim 10 wherein the cleaning and pre-soaking means is a flume destoner.

13. A process for manufacturing dehydrated precooked legumes comprising the steps of:
providing a steam jacketed pressure vessel;
providing a quantity of cleaned legumes;
providing a quantity of water;
positioning the quantity of legumes and the quantity of water in the steam jacketed pressure vessel;
employing the steam jacketed pressure vessel to heat the legumes and water contained therein thereby cooking the legumes;
providing a holding hopper;
discharging the cooked legumes from the steam jacketed pressure vessel into the holding hopper;
providing a perforated conveyor;
discharging the legumes from the holding hopper onto the perforator conveyor;
providing a first dehydrator;
utilizing the perforated conveyor to transport the cooked legumes through the first dehydrator;
utilizing the dehydrator to reduce the moisture content of the cooked legumes;
providing a second dehydrator;
directing the cooked dehydrated legume flakes through the second dehydrator and thereby further reducing the moisture content thereof; and
packaging the precooked dehydrated flaked legumes for distribution and sale following the second dehydration step.

14. A process for manufacturing dehydrated precooked legumes comprising the steps of:
providing a quantity of raw legumes;
providing means for cleaning and pre-soaking the quantity of raw legumes;
providing a quantity of heated water;
positioning the quantity of legumes and the quantity of water in the cleaning and pre-soaking means;
utilizing the cleaning and pre-soaking means and the quantity of water therein to clean and pre-soak the legumes;
providing means for pressure cooking the legumes;
discharging the clean, pre-soaked legumes from the cleaning and pre-soaking means into the pressure cooking means;
providing a second quantity of water;
positioning the clean, pre-soaked legumes and the second quantity of water in the pressure cooking means;
utilizing the pressure cooking means to heat the legumes and the water contained therein thereby cooking the legumes;
providing a holding hopper;
discharging the cooked legumes from the pressure cooking means into the holding hopper;
providing a separating conveyor;
discharging the cooked legumes from the holding hopper onto the separating conveyor;
utilizing the separating conveyor to separate the legumes;
providing means for applying a mist of oil onto the separated, cooked legumes;
utilizing the misting means to mist oil onto the separated, cooked legumes at the distal end of the separating conveyor;
providing a perforated conveyor;
discharging the legumes onto the perforated conveyor;
providing a dehydrator;
providing means for cooling the legumes;
utilizing the perforated conveyor to direct the legumes through the dehydrator and the cooling means;
utilizing the dehydrator to reduce the moisture content of the legumes;
utilizing the cooling means to cool the dehydrated legumes to ambient temperature; and
packaging the cooled, dehydrated legumes for distribution and sale.

15. The process for manufacturing dehydrated precooked legumes according to claim 14 further comprising the steps of:
providing a quantity of heated water for use in conjunction with the separating conveyor;
providing means for spraying the heated water across the legumes on the separating conveyor; and
the water sprayed over the legumes on the separating conveyor facilitating substantially complete separation of the legumes thereon.

16. The process for manufacturing dehydrated precooked legumes according to claim 14 wherein the cleaning and pre-soaking means is a flume destoner.
